(19) United States
(12) Patent Application Publication
(10) Pub. No.: US 2005/0061925 A1
(43) Pub. Date: Mar. 24, 2005

(54) Riser assembly

(75) Inventor: Kraig A. Kirschner, Corona, CA (US)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(73) Assignee: AUTOMATIC FIRE CONTROL , INCORPORATED

(21) Appl. No.: 10/668,116

(22) Filed: Sep. 22, 2003

(51) Int. Cl. F16L 3/00

(52) U.S. Cl. 248/49; 248/74.1; 248/65; 248/62

(57) ABSTRACT

A riser assembly comprising a CPVC standpipe of specified outside diameter receives a riser clamp defined by two identical bars. Each bar has a substantially hemicylindrical section, a long straight section and a short straight section with the hemicylindrical section in the middle. Each straight section has a through hole closely spaced equidistant with the hemicylindrical section to receive fasteners. The long section of each bar is mated with the short section of the other bar. The inside surface of the hemicylindrical section may be radiused a bit to relieve the edges. The resulting riser clamp 12 is designed to receive a riser pipe of specified outside diameter such that the inside diameter of the resulting hole through the riser clamp when fully tightened by the fasteners is smaller than the specified outside diameter of the riser pipe by not to exceed 5%.

### BACKGROUND OF THE INVENTION

The field of the present invention is risers and clamps therefor.

Traditionally fire sprinkler systems in buildings have employed steel pipe. Steel pipe risers in such sprinkler systems are typically supported on each floor of the building. FIG. 1 illustrates a conventional riser clamp which is tightened about a riser using fasteners to either side of the cylindrical portion defined by two hemicylindrical sections. The straight sections to either side of the hemicylindrical portion extend for a substantial distance. This extension is to insure that both straight sections of the clamp will extend to the floor for support around a hole created for passage of the riser therethrough. The fasteners are typically tightened to give very substantial compressive stress in order that the friction between the clamp and the heavy steel riser will retain the riser in place. To obtain such compression, the clamps are defined for use with riser pipes of diameters such that the sections never fully close into juxtaposition when the fasteners are tightened.

CPVC is now employed in fire sprinkler systems in many smaller structure environments. CPVC pipe is far more fragile than steel pipe and also lighter in weight. A nominally four inch diameter SDR 13.5 BlazeMaster® CPVC pipe is 7.986 lbs. per foot when water filled. Conventional clamping devices such as illustrated in FIG. 1 can allow excessive compression and gouging of the CPVC material.

### SUMMARY OF THE INVENTION

The present invention is directed to a riser clamp composed of two bars with each including a substantially hemicylindrical section and straight sections to either side thereof. Fasteners are extendable through through holes to retain the two bars together with the straight sections to either side of the hemicylindrical sections juxtaposed with one another, respectively.

In a first separate aspect of the present invention, the riser clamp is for a fragile pipe of a specified outside diameter. The hemicylindrical sections of the two bars define an inside diameter. This inside diameter is smaller than the specified outside diameter of the fragile pipe by not to exceed 5% with the straight sections of the two bars juxtaposed with one another.

In a second separate aspect of the present invention, the straight sections on each of the two bars include a long straight section and a short straight section such that the long section from each bar is assembled in juxtaposition with a short straight section of the other bar. The hemicylindrical sections of the two bars define an inside diameter. This inside diameter is smaller than the specified outside diameter of the fragile pipe by not to exceed 5% with the straight sections of the two bars juxtaposed with one another.

In a third separate aspect of the present invention, a riser assembly includes the clamp of the foregoing separate aspects with a fragile pipe.

In a fourth separate aspect of the present invention, any of the foregoing aspects are contemplated to be employed in combination to greater advantage.

Accordingly, it is an object of the present invention to provide an improved riser clamp for fragile riser pipe. Other and further objects and advantages will appear hereinafter.

### BRIEF DESCRIPTION OF THE DRAWINGS

FIG. 1 is a plan view of a prior art riser clamp.

FIG. 2 is a perspective view of a riser clamp with a riser illustrated in phantom.

FIG. 3 is a cross-sectional end view of a bar of a riser clamp taken through the hemicylindrical section.

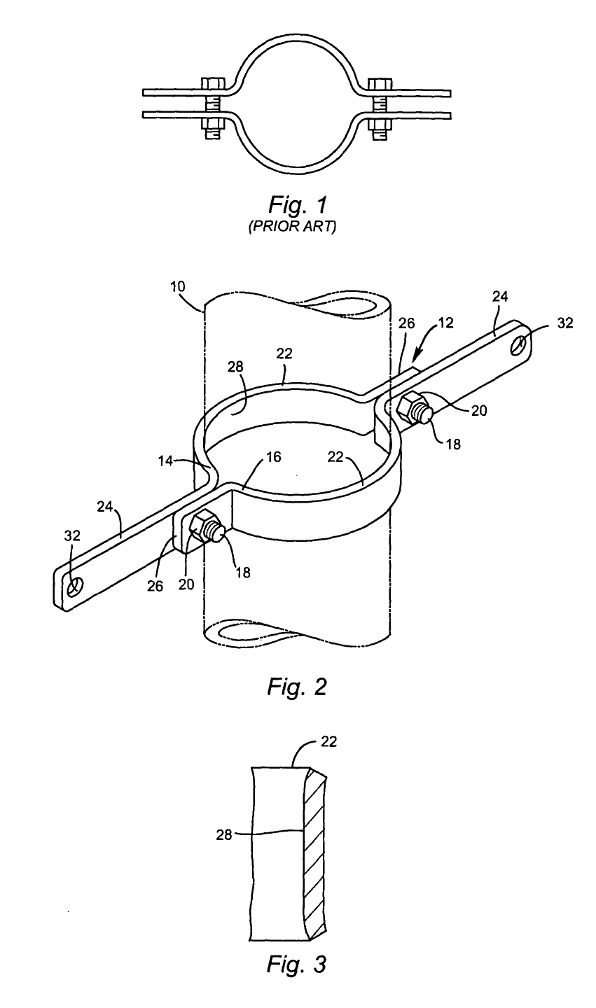

### DETAILED DESCRIPTION OF THE PREFERRED EMBODIMENT

Turning in detail to the Figures, a riser assembly is illustrated in FIG. 2 as including a riser pipe 10, illustrated in phantom. The riser pipe is of CPVC which comes in standard outside diameters. Such pipe is fragile, particularly compared to steel pipe. Nominal pipe sizes provide actual outside diameters as follows:

| Nominal Pipe Size | | Actual Outside Diameter |
|---|---|---|
| 2 | inches | 2.375 inches |
| 2½ | inches | 2.875 inches |
| 3 | inches | 3.500 inches |
| 4 | inches | 4.500 inches |

CPVC is now commonly employed for use in residential construction and certain other similar uses. Such pipe is designed to be used with systems where the fire or smoke sensing system activating the sprinklers is quite sensitive. Such systems are principally used to protect lives rather than property. Because of the low threshold, CPVC is acceptable for fire sprinkler use. However, such pipe is subject to fracture under significant compression and to gouging. Consequently, the installation and support of such material must be carefully accomplished. Among the CPVC piping employed, risers 10 extend vertically from floor to floor. They typically pass through holes located at each floor, providing a convenient location for a riser clamp.

A riser clamp, generally designated 12, is illustrated in FIG. 2 as including two bars 14 and 16. The bars 14 and 16 are held together by two fasteners, each including a bolt 18 and nut 20 threadably mounted on the bolt 18. The bars 14 and 16 are identical but are not mated together in that identity.

Each bar 14 and 16 is unitary in construction but is discussed as including three sections, a substantially hemicylindrical section 22, a long straight section 24 and a short straight section 26. The section 22 is substantially hemicylindrical in that radiused curves at the terminations of this section do not form a part of a cylinder. Further, the concave surface of the substantially hemicylindrical section 22 is radiused at the inside edges to prevent gouging. The inside surface 28 illustrates the break at each edge in FIG. 3.

The long straight section 24 has a length which is greater than the radius of the hemicylindrical section 22. This insures that the clamp 12 can span across the hole in the floor to contact and rest upon the upper surface of the floor through which the riser pipe 10 extends and on top of which the riser clamp 12 is positioned. There is a through hole which is closely spaced from the substantially hemicylindrical section 22 to receive the bolt 18. Near the outer edge, an attachment hole 32 provides the versatility to attach the riser clamp 12 to a convenient framing member or anchor. This attachment hole 32 is closely spaced from the distal end to provide adequate reach to a framing member. Other holes may be added where appropriate.

The short straight section 26 also includes a through hole which is closely spaced from the hemicylindrical section 22. The through holes are equidistant from the hemicylindrical section 22. This placement allows alignment between the bars with the through holes as illustrated in FIG. 2 and provides a substantially uniform clamping about a riser pipe 10.

The bars 14 and 16 are assembled together as illustrated in FIG. 2. The bolts 18 and nuts 20 retain the riser clamp 12 in the assembled state with the bars 14 and 16 juxtaposed with the long straight sections 24 of each of the bars 14 and 16 being assembled with the short straight sections 26 as shown. The assembled riser clamp 12 is sized such that the hemicylindrical sections 22 define an inside diameter which is smaller than the outside diameter of a specified standard CPVC pipe outside diameter by not to exceed 5%. This is to be with the straight sections juxtaposed. Such sections may include additional plates or washers about the through holes as part of the straight sections to define this specific size relationship between the inside diameter of the riser clamp 12 and the outside diameter of the riser pump 10. Thus, the riser clamp 12 as applied to a riser pipe 10 will not crush the fragile pipe and further will not gouge the pipe at a sharp edge.

Thus, an improved riser clamp 12 is disclosed. While embodiments and applications of this invention have been shown and described, it would be apparent to those skilled in the art that many more modifications are possible without departing from the inventive concepts herein. The invention, therefore is not to be restricted except in the spirit of the appended claims.

1. A riser clamp for fragile pipe of a specified outside diameter, comprising
two bars, each bar including a substantially hemicylindrical section, a first straight section on one end of the hemicylindrical section and a second straight section on the other end of the hemicylindrical section, each straight section having a through hole closely spaced equidistant from the hemicylindrical section;
fasteners extendable through the through holes to retain the two bars together with the first straight sections juxtaposed with the second straight sections, respectively, the hemicylindrical sections of the two bars defining an inside diameter smaller than the specified outside diameter by not to exceed five percent with the first straight sections juxtaposed with the second straight sections, respectively.

2. The riser clamp of claim 1, the two bars each having radiused inside edges at least along the hemicylindrical section.

3. The riser clamp of claim 1, the fasteners each being a bolt with a nut threadable thereon.

4. A riser clamp for fragile pipe of a specified outside diameter, comprising
two bars, each bar including a substantially hemicylindrical section, a long straight section on one end of the hemicylindrical section and a short straight section on the other end of the hemicylindrical section, each straight section having a through hole closely spaced equidistant from the hemicylindrical section;
fasteners extendable through the through holes to retain the two bars together with the long straight sections juxtaposed with the short straight sections, respectively, the hemicylindrical sections of the two bars defining an inside diameter smaller than the specified outside diameter by not to exceed five percent with the long straight sections juxtaposed with the short straight sections, respectively.

5. The riser clamp of claim 4, the two bars each having radiused inside edges at least along the hemicylindrical section.

6. The riser clamp of claim 4, the fasteners each being a bolt with a nut threadable thereon.

7. The riser clamp of claim 4, the long straight sections each having an attachment hole closely spaced from the distal end thereof.

8. A riser assembly comprising
fragile pipe of a specified outside diameter;
a clamp including two bars, each bar having a substantially hemicylindrical section, a first straight section on one end of the hemicylindrical section and a second straight section on the other end of the hemicylindrical section, each straight section having a through hole closely spaced equidistant from the hemicylindrical section, at least one of the first straight section and the second straight section on each of the two bars having a length greater than the radius of the hemicylindrical section, and fasteners extending through the through holes to retain the two bars together with the first straight sections juxtaposed with the second straight sections, respectively, the hemicylindrical sections of the two bars defining an inside diameter smaller than the specified outside diameter by not to exceed five percent with the first straight sections juxtaposed with the second straight sections, respectively.

9. The riser assembly of claim 8, the two bars each having radiused inside edges at least along the hemicylindrical section.

10. The riser assembly of claim 8, the fasteners each being a bolt with a nut threadable thereon.

11. The riser assembly of claim 8, the first straight section being a long straight section and the second straight section being a short straight section.

12. The riser assembly of claim 11, the long straight sections each having an attachment hole closely spaced from the distal end thereof.

13. The riser assembly of claim 8, the fragile pipe being CPVC. 13.
The riser assembly of claim 8, the fragile pipe being CPVC.

14. The riser assembly of claim 13, the specified outside diameter being a standard CPVC pipe outside diameter of one of 2.375 inches, 2.875 inches, 3.500 inches and 4.500 inches.

15. The riser assembly of claim 1, the first straight section on each of the two bars having a length greater than the radius of the hemicylindrical section.
